(19) United States
(12) Patent Application Publication
(10) Pub. No.: US 2012/0220482 A1
(43) Pub. Date: Aug. 30, 2012

(54) COMPOSITIONS AND METHODS FOR SCREENING PEPTOID LIBRARIES

(75) Inventors: Muralidhar Reddy MOOLA, Jupiter, FL (US); JOHN M. ASTLE, Branford, CT (US); THOMAS KODADEK, Jupiter, FL (US)

(73) Assignee: The Board of Regents of the University of Texas System, Austin, TX (US)

(21) Appl. No.: 13/396,267

(22) Filed: Feb. 14, 2012

Related U.S. Application Data
(60) Provisional application No. 61/447,020, filed on Feb. 26, 2011.

(51) Int. Cl. C40B 30/04

(52) U.S. Cl. 506/9

(57) ABSTRACT

Certain embodiments are directed to methods for screening synthetic libraries and characterizing the resultant hits that combines many of the attractive features of bead library screening and microarray-based analysis in a seamless fashion.

This application claims benefit of priority to U.S. Provisional Application Ser. No. 61/447,020, filed Feb. 26, 2011, the entire contents of which are hereby incorporated by reference.

The invention was made with government support under Grant No. DP110D000663-01 awarded by the National Institutes of Health. The government has certain rights in the invention.

### BACKGROUND OF THE INVENTION

I. Field of the Invention

Embodiments of this invention are directed generally to biology and medicine. Certain embodiments are directed to methods for screening synthetic libraries and characterizing the resultant hits by combining features of bead library screening and microarray-based analysis.

II. Background

The discovery of synthetic molecules able to recognize proteins with high specificity and affinity is an issue of great current interest. Currently, most synthetic molecules are discovered through screening efforts, of which there are two broad types. The first is functional screens, in which small, soluble molecules are introduced into the wells of microtiter plates and assayed individually for their ability to alter the activity of an enzyme, elicit a certain phenotype in a cell, and so on. Functional screens, while powerful, have several limitations. It is impractical to screen more than approximately 1,000,000 different compounds, and even this is a major undertaking. Because of the necessity of handling a large number of individual compounds, an elaborate infrastructure of automated instrumentation is required, and these screens are expensive.

Alternatively, one can employ binding assays. For libraries of synthetic molecules, the compounds of interest are generally displayed on a suitable solid support and exposed to a soluble, labeled protein under the desired conditions, and retention of the label is monitored. This approach was developed first for bead displayed peptide libraries created by split and pool synthesis (Lam et al., 1991), where each bead displays many copies of a single molecule. The identity of the “hits” in a bead-binding assay must be determined post-screening. For peptides and certain other oligomeric molecules (Alluri et al., 2003), sensitive analytical techniques are available that allow the structure of the hits to be determined directly from a single bead. If this is not the case, various encoding strategies can be employed to characterize the structure of hits indirectly. (Liu et al., 2002; Ohlmeyer et al., 1993). More recently, microarrays have been employed in binding screens (Lam and Renil, 2002; MacBeath et al., 1999; Uttamchandani et al., 2005). In this format, thousands of different molecules are printed onto chemically modified glass slides so as to become attached covalently to the surface (Bradner et al., 2006; Kuruvilla et al., 2002).

Bead-based and microarray screening have complementary strengths and weaknesses. The major advantage of bead-based screens is that a large number of compounds can be screened easily and cheaply in a single experiment. This is because the binding screen is done as a batch assay, and it is unnecessary to spatially segregate all of the beads prior to the screen. Microarray fabrication does require the physical separation of compounds into the wells of microtiter plates prior to spotting, and thus requires some, but not all, of the infrastructure employed for functional screening. Moreover, the number of compounds that can be spotted onto a single slide is limited to a few tens of thousands. On the other hand, many microarrays can be made from small amounts of compounds, facilitating quantitative analysis via titration experiments. In addition, in any one experiment, the relative binding characteristics of all of the compounds on the array can be compared. Such studies are difficult to do with bead libraries, because labor-intensive resynthesis and detailed binding studies are usually required to identify the best ligands from the large number of hits that may result from a bead-based screen.

### SUMMARY OF THE INVENTION

Certain embodiments are directed to methods for screening synthetic libraries and characterizing the resultant hits that combines many of the attractive features of bead library screening and microarray-based analysis in a seamless fashion. This allows very large libraries of millions of compounds to be screened rapidly and cheaply for the highest affinity protein ligands present. The key features of this method are the separation of hits from nonhits using magnetic capture, and the ability to both identify the sequence of the hits and spot them onto microarrays for subsequent quantitative analysis without the need for hit resynthesis. This approach allows millions of synthetic molecules to be analyzed quickly and easily for binding to a protein of interest, and greatly facilitates the determination of which of these compounds exhibits the best affinity and specificity for the target.

Several approaches have been developed for screening combinatorial libraries or collections of synthetic molecules for agonists or antagonists of protein function, each with its own advantages and limitations. The experimental platform described herein seamlessly couples massively parallel bead-based screening of one-bead one-compound (OBOC) combinatorial libraries with microarray-based quantitative comparisons of the binding affinities of the many hits isolated from the bead library. Combined with other technical improvements, this technique allows the rapid identification of the best protein ligands in combinatorial libraries containing millions of compounds without the need for labor-intensive resynthesis of the hits.

Certain embodiments include contacting a library of 75 μm TentaGel beads from a one-bead one-compound (OBOC) library, which can contain millions of peptoids) with a target (e.g., a protein of interest), washing, and coupling any bead/target complexes to a separation moiety (e.g., a iron-oxide particle). Bead/target complexes are isolated from non-binding beads by contacting the bead/target complex with anti-target antibodies or other moieties that specifically bind the target linked covalently to iron oxide-containing particles (Dynabeads) or other affinity targets that can be sequestered or used to isolate components from a solution. Beads that bind the target, and therefore also tagged for isolation (e.g., attract Dynabeads), are retained (e.g., retained on the side of the tube using a powerful magnet), and those beads not tagged for isolation (e.g., nonmagnetic beads) are removed. Each of the putative “hit” beads is separated into the well of a microtiter plate, and the compounds are removed from the beads by cleavage of a linker. The compounds are then spotted onto an array forming a compound microarray (e.g., a maleimide-activated glass slide via a Diels-Alder reaction involving a conserved furan-containing monomer incorporated into each sequence). The structure of each putative hit is deduced by tandem MS. The compound microarrays are then probed with different concentrations of the target to determine the intrinsic affinity of each of the hit compounds for the target. In this way, no resynthesis of the hits is necessary until the best binders are identified.

In certain aspects methods are directed to selecting a peptoid comprising one or more of the following steps: (1) contacting a peptoid library with a target, the peptoid library comprising a plurality of beads with each bead being coupled to a specific peptoid via a cleavable linker; (2) selecting a target bound peptoid by coupling the target with a magnetic particle forming a magnetic particle complex; and (3) isolating the magnetic particle complex containing the target bound peptoid.

In certain aspects the method further comprises separating individual magnetic particle complexes into separate wells or containers. Selected peptoid can be removed from the bead by cleaving the linker between the bead and the peptoid. In certain aspects cleaving the link between the bead and the selected peptoid is by exposure to cyanogen bromide or trifluoro-acetic acid (TFA), such as solutions or sprays containing these reagents. The method can further comprise cleaving the link between the bead and the selected peptoid and attaching the selected peptoid to a substrate forming a selected peptoid array.

In certain aspects a selected peptoid array is formed by microarray spotting or other methods of array or microarray spotting known in the art. In certain aspects a cleaved peptoid comprises a furan group for coupling to the substrate. In a further aspect the substrate is glass, such as maleimide-modified glass.

In certain aspects the target is a polypeptide, a carbohydrate, lipid, cell, organism, or the like. In certain aspect the target can be presented on the surface of a cell or particle. A cell can be a eukaryotic cell, a prokaryotic cell, or a phage particle.

In certain aspects the method can further comprise contacting the array with varying concentrations of the target and assessing binding of the target to the selected peptoid array at the various concentrations.

Other embodiments of the invention are discussed throughout this application. Any embodiment discussed with respect to one aspect of the invention applies to other aspects of the invention as well and vice versa. The embodiments in the Example section are understood to be embodiments of the invention that are applicable to all aspects of the invention.

The use of the word “a” or “an” when used in conjunction with the term “comprising” in the claims and/or the specification may mean “one,” but it is also consistent with the meaning of “one or more,” “at least one,” and “one or more than one.”

It is contemplated that any embodiment discussed herein can be implemented with respect to any method or composition of the invention, and vice versa. Furthermore, compositions and kits of the invention can be used to achieve methods of the invention.

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.” It is also contemplated that anything listed using the term “or” may also be specifically excluded.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1. Overview of the Integrated Magnetic Screening and Testing of Hits on Microarrays. Millions of 75 μm TentaGel beads from a one-bead one-compound (OBOC) library are incubated with target protein (for example an anti-FLAG antibody), washed, and then incubated with anti-target protein antibodies linked covalently to iron oxide-containing particles (Dynabeads). Beads that bind the target protein, and therefore also attract Dynabeads, are retained on the side of the tube using a powerful magnet, and nonmagnetic beads are removed. Each of the putative “hit” beads is separated into the well of a microtiter plate, and the compounds are removed from the beads by cleavage of a linker. The compounds are then spotted onto a maleimide-activated glass slide via a Diels-Alder reaction involving a conserved furan-containing monomer incorporated into each sequence. The structure of each putative hit is deduced by tandem MS. The compound microarrays are then probed with different concentrations of the target protein to determine the intrinsic affinity of each of the hit compounds for the target. In this way, no resynthesis of the hits is necessary until the best binders are identified.

FIGS. 2A-2C. Composition of the Combinatorial Employed in This Study. The general structure is X-X-X-X-X-X-Nffa-Met, where X is any of the peptide or peptoid monomers shown. (FIG. 2A) Structures of an L-peptide, a D-peptide, and a peptoid. (FIG. 2B) Structures of the monomers used for library synthesis. (FIG. 2C) The submonomer synthesis approach, which illustrates how the amines shown in FIG. 2B were incorporated into the library. The amino acids were incorporated with standard peptide couplings.

FIG. 3. Microarray-Based Analysis of the Hits Isolated in the Magnet-Assisted Screening Procedure. A total of 16 replicate arrays of hit compounds, as well as positive and negative controls, were spotted onto each of three microarray slides and hybridized with anti-Myc antibody or decreasing concentrations of anti-FLAG antibody, followed by red fluorescently labeled secondary antibodies. Displayed is the image of one of the three slides (right), with the 100 nM and 763 pM anti-FLAG antibody hybridized portions of the slide magnified (left). Anti-Myc antibody only binds Myc peptide, while anti-FLAG antibody binds FLAG peptide as well as many of the hits, but not the negative controls. The binding curves for FLAG peptide and two of the best hits are shown on the bottom. A1-E8, G10-I1=hits from X-X-X-X-X-X-Nffa-Met library screen; E9-G9=negatives from the screen; I2-I7=FLAG peptide; I9-J4=Myc peptide; I8, J5-J10=blank. See Table 1 for sequences and binding affinities. Error bars represent the range observed in three independent experiments.

### DETAILED DESCRIPTION OF THE INVENTION

Embodiments described herein establish a screening strategy that will allow millions of bead-displayed compounds to be screened on resin rapidly and cheaply, followed by transfer of the hits to a microarray where their binding to the target of interest could be quantified and/or characterized. The inventors previous work has shown that TentaGel, comprised of a polystyrene core coated with very long amine-terminated polyethylene glycol (PEG) chains is a superior bead surface for protein-binding screens due to its low nonspecific protein-binding capacity (Alluri et al., 2003). However, there is no simple way to release molecules built off of the terminal amine group from the resin. Therefore, The inventors developed of a suitable linker arm that would support both efficient cleavage of hits from the beads and subsequent spotting onto maleimide-modified glass slides (Reddy and Kodadek, 2005).

In certain aspects of the invention, two linker types were explored, both based on well-known protocols for the specific cleavage of proteins: the cyanogen bromide-mediated cleavage C-terminal of methionine (Thakkar et al., 2009), and hydrolysis of the Asp-Pro peptide bond with dilute trifluoroacetic acid (TFA) (Crimmins et al., 2005). In the case of the Asp-Pro linker, a Cys residue was included to facilitate Michael addition of the cleaved molecule to the maleimide-terminated slides. In the Met-containing linkers, it was found that a Cys residue led to side-reactions that decreased the purity of cleaved compounds, and rendered identification of the hit compounds difficult (data not shown). Therefore, a furan-containing peptoid residue (Nffa) was incorporated for attachment. This supports linkage to the array via Diels-Alder reaction (Houseman et al., 2002). The inventors demonstrate that enough compound is produced from cleavage of a single bead with CNBr or dilute TFA to sequence the peptide using tandem MALDI mass spectrometry (MS). Moreover, when the compound was spotted onto an array and probed, enough antibody was captured to easily detect a signal upon subsequent incubation with fluorescently labeled secondary antibody. In certain aspects the Nffa-Met linker is employed.

It will be understood that all the screening methods of the present invention are useful in themselves notwithstanding the fact that effective candidates may not be found. The invention provides methods for screening for such candidates, not solely methods of finding them. It will also be appreciated that the present invention comprises peptoids found or discovered using the methods described herein.

### I. Peptoid Libraries and Arrays

Details regarding design of peptoid libraries have been published previously (Udugamasooriya et al., 2008). Briefly, the library can be synthesized on TentaGel macrobeads. Synthesis of the library is conducted using various amines resulting in a diverse library of compounds. The library can be synthesized using a microwave (1000 W)-assisted synthesis protocol and a split and pool method (Olivos et al., 2002).

Peptoids may employ modified, non-natural and/or unusual amino acids. Chemical synthesis may be employed to incorporate such residues into compounds of interest. Non-natural residues include, but are not limited to Aad (2-Aminoadipic acid), EtAsn (N-Ethylasparagine), Baad (3-Aminoadipic acid), Hyl (Hydroxylysine), Bala (beta-alanine), Ahyl (allo-Hydroxylysine propionic acid), Abu (2-Aminobutyric acid), 3Hyp (3-Hydroxyproline), 4Abu (4-Aminobutyric acid), 4Hyp (4-Hydroxyproline piperidinic acid), Acp (6-Aminocaproic acid), Ide (Isodesmosine), Ahe (2-Aminoheptanoic acid), Aile (allo-Isoleucine), Aib (2-Aminoisobutyric acid), MeGly (N-Methylglycine), Baib (3-Aminoisobutyric acid), Melle (N-Methylisoleucine), Apm (2-Aminopimelic acid), MeLys (6-N-Methyllysine), Dbu (2,4-Diaminobutyric acid), MeVal (N-Methylvaline), Des (Desmosine), Nva (Norvaline), Dpm (2,2′-Diaminopimelic acid), Nle (Norleucine), Dpr (2,3-Diaminopropionic acid), Orn (Ornithine), and EtGly (N-Ethylglycine).

The term “attach” or “attached” as used herein, refers to connecting or uniting by a bond, link, force or tie in order to keep two or more components together, which encompasses either direct or indirect attachment such that for example where a first molecule is directly bound to a second molecule or material, and the embodiments wherein one or more intermediate molecules are disposed between the first molecule and the second molecule or material.

A “protecting group” is a moiety which is bound to a molecule and designed to block one reactive site in a molecule, but may be spatially removed upon selective exposure to an activator or a deprotecting reagent. Several examples of protecting groups are known in the literature. The proper selection of protecting group (also known as protective group) for a particular synthesis would be governed by the overall methods employed in the synthesis. Activators include, for example, electromagnetic radiation, ion beams, electric fields, magnetic fields, electron beams, x-ray, and the like. A deprotecting reagent could include, for example, an acid, a base or a free radical. Protective groups are materials that bind to a monomer, a linker molecule or a pre-formed molecule to protect a reactive functionality on the monomer, linker molecule or pre-formed molecule, which may be removed upon selective exposure to an activator, such as an electrochemically generated reagent. Protective groups that may be used in accordance with an embodiment of the invention preferably include all acid and base labile protecting groups. For example, amine groups can be protected by t-butyloxycarbonyl (BOC) or benzyloxycarbonyl (CBZ), both of which are acid labile, or by 9-fluorenylmethoxycarbonyl (FMOC), which is base labile. Additionally, hydroxyl groups on phosphoramidites may be protected by dimethoxytrityl (DMT), which is acid labile.

Any unreacted deprotected chemical functional groups may be capped at any point during a synthesis reaction to avoid or to prevent further bonding at such molecule. Capping groups “cap” deprotected functional groups by, for example, binding with the unreacted amino functions to form amides. Capping agents suitable for use in an embodiment of the invention include: acetic anhydride, n-acetylimidizole, isopropenyl formate, fluorescamine, 3-nitrophthalic anhydride and 3-sulfoproponic anhydride.

Additional protecting groups that may be used in accordance with an embodiment of the invention include acid labile groups for protecting amino moieties: tertbutyloxycarbonyl, tert-amyloxycarbonyl, adamantyloxycarbonyl, 1-methylcyclobutyloxycarbonyl, 2-(p-biphenyl)propyl(2)oxycarbonyl, 2-(p-phenylazophenylyl)propyl(2)oxycarbonyl, alpha, alpha-dimethyl-3,5-dimethyloxybenzyloxy-carbonyl, 2-phenylpropyl(2)oxycarbonyl, 4-methyloxybenzyloxycarbonyl, benzyloxycarbonyl, furfuryloxycarbonyl, triphenylmethyl (trityl), p-toluenesulfenylaminocarbonyl, dimethylphosphinothioyl, diphenylphosphinothioyl, 2-benzoyl-1-methylvinyl, o-nitrophenylsulfenyl, and 1-naphthylidene; as base labile groups for protecting amino moieties: 9-fluorenylmethyloxycarbonyl, methylsulfonylethyloxycarbonyl, and 5-benzisoazolylmethyleneoxycarbonyl; as groups for protecting amino moieties that are labile when reduced: dithiasuccinoyl, p-toluene sulfonyl, and piperidino-oxycarbonyl; as groups for protecting amino moieties that are labile when oxidized: (ethylthio)carbonyl; as groups for protecting amino moieties that are labile to miscellaneous reagents, the appropriate agent is listed in parenthesis after the group: phthaloyl (hydrazine), trifluoroacetyl (piperidine), and chloroacetyl (2-aminothiophenol); acid labile groups for protecting carboxylic acids: tert-butyl ester; acid labile groups for protecting hydroxyl groups: dimethyltrityl; and basic labile groups for protecting phosphotriester groups: cyanoethyl.

A. Purification of Peptoids

It may be desirable to purify peptoids. Purification techniques are well known to those of skill in the art. These techniques typically involve chromatographic and electrophoretic techniques to achieve partial or complete purification (or purification to homogeneity). Analytical methods particularly suited to the preparation of a pure peptoid are ion-exchange chromatography, exclusion chromatography; polyacrylamide gel electrophoresis; isoelectric focusing. A particularly efficient method of purifying peptoids is fast protein liquid chromatography or even HPLC.

Certain aspects of the present invention concern the purification, and in particular embodiments, the substantial purification, of a peptoid. The term “purified peptoid” as used herein, is intended to refer to a composition, isolatable from other components, wherein the peptoid is purified to any degree relative to its normally-obtainable state. A purified peptoid therefore also refers to a peptoid free from the environment in which it may normally occur.

Generally, “purified” will refer to a peptoid composition that has been subjected to fractionation to remove various other components, and which composition substantially retains its expressed biological activity. Where the term “substantially purified” is used, this designation will refer to a composition in which the peptoid forms the major component of the composition, such as constituting about 50%, about 60%, about 70%, about 80%, about 90%, about 95% or more of the composition by weight.

Various methods for quantifying the degree of purification of the peptoid will be known to those of skill in the art in light of the present disclosure. These include, for example, determining the specific activity of an active fraction, or assessing the amount of peptoid within a fraction by SDS/PAGE analysis. A preferred method for assessing the purity of a fraction is to calculate the specific activity of the fraction, to compare it to the specific activity of the initial extract, and to thus calculate the degree of purity, herein assessed by a “-fold purification number.” The actual units used to represent the amount of activity will, of course, be dependent upon the particular assay technique chosen to follow the purification and whether or not the peptoid exhibits a detectable activity.

B. Peptoid Array

The term “substrate,” as used herein, indicates a base material on which processing can be conducted to modify or synthesize a molecule on the surface of the base material or a based material upon which an array of molecules are attached to be used in screening methods (array substrate). Exemplary chemical modifications of a substrate include functionalization and/or depositing a peptoid or an initial residue or base of a peptoid on the surface layer of a base material that is capable of chemically coupling to a peptoid of the invention or a initiator of such a peptoid.

Support materials useful in embodiments of the present invention include, for example, silicon, bio-compatible polymers such as, for example poly(methyl methacrylate) (PMMA) and polydimethylsiloxane (PDMS), TentaGel resins and beads, glass, SiO2 (such as, for example, a thermal oxide silicon wafer such as that used by the semiconductor industry), quartz, silicon nitride, functionalized glass, gold, platinum, and aluminum. Functionalized surfaces include for example, amino-functionalized glass, carboxy functionalized glass, hydroxy functionalized glass, and amide functionalized beads. Additionally, a support may be coated with one or more layers to provide a surface for molecular attachment or functionalization, increased or decreased reactivity, binding detection, or other specialized application. Support materials and or layer(s) may be porous or non-porous. For example, a support may be comprised of porous silicon. Additionally, the support may be a silicon wafer or chip such as those used in the semiconductor device fabrication industry. A person skilled in the art would know how to select an appropriate support material.

The term “functionalization” as used herein relates to modification of a solid substrate to provide a plurality of functional groups on the substrate surface. By a “functionalized surface” as used herein is meant a substrate surface that has been modified so that a plurality of functional groups are present thereon. The term “functional group” as used herein indicates specific groups of atoms within a molecular structure that are responsible for the characteristic chemical reactions of that structure. Exemplary functional groups include, hydrocarbons, groups containing halogen, groups containing oxygen, groups containing nitrogen and groups containing phosphorus and sulfur all identifiable by a skilled person.

The peptoids present on an array or bead may be linked covalently or non-covalently to the array, and can be attached to the array or bead support (e.g., silicon or other relatively flat material) by cleavable linkers. A linker molecule can be a molecule inserted between the support and peptoid that is being synthesized, and a linker molecule may not necessarily convey functionality to the resulting peptoid, such as molecular recognition functionality, but instead elongates the distance between the support surface and the peptoid functionality to enhance the exposure of the peptoid functionality on the surface of the support.

Preferably a linker should be about 4 to about 40 atoms long. The linker molecules may be, for example, aryl acetylene, ethylene glycol oligomers containing 2-10 monomer units (PEGs), diamines, diacids, amino acids, among others, and combinations thereof. Examples of diamines include ethylene diamine and diamino propane. Alternatively, the linkers may be the same molecule type as that being synthesized, such as peptoids. A person skilled in the art would know how to design appropriate linkers.

The substrate is typically chemically modified to attach one or more functional groups. The term “attach” or “attached” as used herein, refers to connecting or uniting by a bond, link, force or tie in order to keep two or more components together, which encompasses either direct or indirect attachment such that for example where a first compound is directly bound to a second compound or material, and the embodiments wherein one or more intermediate compounds, and in particular molecules, are disposed between the first compound and the second compound or material.

In particular, in polymer arrays selected functional groups that are able to react with a polymer of choice that forms the polymer arrays are attached to the functionalized substrate surface so that they are presented on the surface. The term “present” as used herein with reference to a compound or functional group indicates attachment performed to maintain the chemical reactivity of the compound or functional group as attached. Accordingly, a functional group presented on a surface, is able to perform under the appropriate conditions the one or more chemical reactions that chemically characterize the functional group.

In those embodiments where an array includes two or more features immobilized on the same surface of a solid support, the array may be referred to as addressable. An array is “addressable” when it has multiple regions of different moieties (e.g., different peptoids) such that a region (e.g., a “feature” or “spot” of the array) at a particular predetermined location (e.g., an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “probe” may be the one which is to be evaluated by the other (thus, either one could be an unknown mixture of analytes, e.g., antibodies, to be evaluated by binding with the other).

As one of ordinary skill in the art will realize, although any desired chemical compound capable of forming an attachment with the solid support may be utilized, it is preferred that those peptoids generated from split-and-pool library or parallel syntheses are utilized. As will be appreciated by one of ordinary skill in the art, the use of split-and-pool libraries enables the more efficient generation and screening of compounds. However, peptoid molecules synthesized by parallel synthesis methods and by traditional methods can also be utilized in the compositions and methods of the present invention.

As mentioned above, the use of parallel synthesis methods are also applicable. Parallel synthesis techniques traditionally involve the separate assembly of products in their own reaction vessels. For example, a microtiter plate containing n rows and m columns of tiny wells which are capable of holding a small volume of solvent in which the reaction can occur, can be utilized. Thus, n variants of reactant type A can be reacted with m variants of reactant type B to obtain a library of n×m compounds.

Subsequently, once the desired compounds have been provided using an appropriate method, solutions of the desired compounds are prepared. In a certain aspects, compounds are synthesized on a solid support and the resulting synthesis beads are subsequently distributed into microtiter plates at a density of one bead per well. In certain aspects, beads are distributed after the initial selection via magnetic particles, as described herein. Typically, the attached compounds are then released from their beads and dissolved in a small volume of suitable solvent. In a particular embodiments a high-precision transcription array robot (Schena et al., 1995; Shalon et al., 1996); each of which is incorporated herein by reference) can be used to pick up a small volume of dissolved compound from each well and repetitively deliver appropriate volumes of solution to defined locations on a series of functionalized glass substrates. This results in the formation of microscopic spots of compounds on the array substrate. In addition to a high precision array robot (e.g., OmniGrid® 100 Microarrayer (Genomic Solutions)), other means for delivering the compounds can be used, including, but not limited to, ink jet printers, piezoelectric printers, and small volume pipetting robots.

Each peptoid can contain a common functional group that mediates attachment to a support surface. It is preferred that the attachment formed is robust, for example covalent ester, thioester, or amide attachments. In addition to the robustness of the linkage, other considerations include the solid support to be utilized and the specific class of compounds to be attached to the support. Supports include, but are not limited to glass slides, polymer supports or other solid-material supports, and flexible membrane supports. Examples of supports suitable for use in embodiments of the invention are described in U.S. Pat. No. 5,617,060 and PCT Publication WO 98/59360, each of which are incorporated by reference.

In another embodiment the compounds are attached by nucleophilic addition of a functional group of the compounds being arrayed to an electrophile such as isocyanate or isothiocyanate. Functional groups found useful in adding to an isocyanate or isothiocyanate include primary alcohols, secondary alcohols, phenols, thiols, anilines, hydroxamic acid, aliphatic amines, primary amides, and sulfonamides. In certain embodiments, the nucleophilic addition reaction is catalyzed by a vapor such as pyridine. Other volatile nucleophilic reagents may also be used. In certain embodiments, the nucleophile includes an amine. In certain embodiments, a heteroaryl reagent is used.

The support can be optionally washed and dried, and may be stored at −20° C. for months prior to screening.

Arrays utilized in this invention may include between about 10, 100, 1,000, 2,000, 3,000, 4,000, 5,000, 6,000, 7,000, 8,000, 9,000, 10,000, 12,500 to 25,000, 50,000, 75,000, to about 100,000 distinct cyclic peptoids, including values and ranges there between.

C. Linkers

The present invention may comprise peptoids joined to various substrates and/or molecules via a linker. Any of a wide variety of linkers may be utilized to effect the joinder of peptoids. Certain linkers will generally be preferred over other linkers, based on differing pharmacologic characteristics and capabilities. In particular, the linkers will be attached at the free —OH group of a peptoid. In certain aspects the linker will be a cleavable linker, such as cyanogens bromide cleavable linker or a trifluoro-acetic acid (TFA) cleavable linker. The peptoid once removed from the linker will contain a functional group for attachment to a substrate, such as a methionine, a furan, or another functional group described herein.

Cross-linking reagents are used to form molecular bridges that tie together functional groups of two molecules. Linking/coupling agents used to combine to peptoids or to couple the peptoids to various substrates include linkages such as avidin-biotin, amides, esters, thioesters, ethers, thioethers, phosphoesters, phosphoramides, anhydrides, disulfides, and ionic and hydrophobic interactions.

An exemplary hetero-bifunctional cross-linker contains two reactive groups: one reacting with primary amine group (e.g., N-hydroxy succinimide) and the other reacting with a thiol group (e.g., pyridyl disulfide, maleimides, halogens, etc.). Through the primary amine reactive group, the cross-linker may react with a surface or substrate and through a thiol reactive group reacts with a peptoid composition comprising an attachment residue having a thiol group. Numerous types of disulfide-bond containing linkers are known that can be successfully employed in the methods described herein.

Another cross-linking reagent is SMPT, which is a bifunctional cross-linker containing a disulfide bond that is “sterically-hindered” by an adjacent benzene ring and methyl groups. It is believed that steric hindrance of the disulfide bond serves a function of protecting the bond from attack by thiolate anions such as glutathione which can be present in tissues and blood, and thereby help in preventing decoupling of the conjugate prior to the delivery of the attached agent in vivo. The SMPT cross-linking reagent, as with many other known cross-linking reagents, lends the ability to cross-link functional groups such as the SH of cysteine or primary amines (e.g., the epsilon amino group of lysine). Another possible type of cross-linker includes the hetero-bifunctional photoreactive phenylazides containing a cleavable disulfide bond such as sulfosuccinimidyl-2-(p-azido salicylamido) ethyl-1,3′-dithiopropionate. The N-hydroxy-succinimidyl group reacts with primary amino groups and the phenylazide (upon photolysis) reacts non-selectively with any amino acid residue.

In addition to hindered cross-linkers, non-hindered linkers also can be employed in accordance herewith. Other useful cross-linkers, not considered to contain or generate a protected disulfide, include SATA, SPDP and 2-iminothiolane (Wawrzynczak & Thorpe, 1988). The use of such cross-linkers is well understood in the art. Another embodiment involves the use of flexible linkers. U.S. Pat. No. 4,680,338, describes bifunctional linkers useful for producing conjugates of ligands with amine-containing polymers and/or proteins, especially for forming antibody conjugates with chelators, drugs, enzymes, detectable labels and the like. U.S. Pat. Nos. 5,141,648 and 5,563,250 disclose cleavable conjugates containing a labile bond that is cleavable under a variety of mild conditions. This linker is particularly useful in that the agent of interest may be bonded directly to the linker, with cleavage resulting in release of the active agent.

Peptide linkers that include a chemical cleavage site or a cleavage site for an enzyme also are contemplated. Exemplary forms of such peptide linkers are those that are cleaved by urokinase, plasmin, thrombin, Factor IXa, Factor Xa, or a metallaproteinase, such as collagenase, gelatinase, or stromelysin.

### II. Detection Methods

Methods for detecting targets captured or bound on a solid support can generally be divided into photometric methods of detection and non-photometric methods of detection.

Photometric methods of detection include, without limitation, those methods that detect or measure absorbance, fluorescence, refractive index, polarization or light scattering. Methods involving absorbance include measuring light absorbance of an analyte directly (increased absorbance compared to background) or indirectly (measuring decreased absorbance compared to background). Measurement of ultraviolet, visible and infrared light all are known. Methods involving fluorescence also include direct and indirect fluorescent measurement. Methods involving fluorescence include, for example, fluorescent tagging in immunological methods such as ELISA or sandwich assay. Methods involving measuring refractive index include, for example, surface plasmon resonance (“SPR”), grating coupled methods (e.g., sensors uniform grating couplers, wavelength-interrogated optical sensors (“WIOS”) and chirped grating couplers), resonant mirror and interferometric techniques. Methods involving measuring polarization include, for example, ellipsometry. Light scattering methods (nephelometry) may also be used.

Non-photometric methods of detection include, without limitation, magnetic resonance imaging, gas phase ion spectrometry, atomic force microscopy and multipolar coupled resonance spectroscopy. Magnetic resonance imaging (MRI) is based on the principles of nuclear magnetic resonance (NMR), a spectroscopic technique used by scientists to obtain microscopic chemical and physical information about molecules. Gas phase ion spectrometers include mass spectrometers, ion mobility spectrometers and total ion current measuring devices.

Mass spectrometers measure a parameter which can be translated into mass-to-charge ratios of ions. Generally ions of interest bear a single charge, and mass-to-charge ratios are often simply referred to as mass. Mass spectrometers include an inlet system, an ionization source, an ion optic assembly, a mass analyzer, and a detector. Several different ionization sources have been used for desorbing and ionizing analytes from the surface of a support or biochip in a mass spectrometer. Such methodologies include laser desorption/ionization (MALDI, SELDI), fast atom bombardment, plasma desorption, and secondary ion mass spectrometers. In such mass spectrometers the inlet system comprises a support interface capable of engaging the support and positioning it in interrogatable relationship with the ionization source and concurrently in communication with the mass spectrometer, e.g., the ion optic assembly, the mass analyzer and the detector. Solid supports for use in bioassays that have a generally planar surface for the capture of targets and adapted for facile use as supports with detection instruments are generally referred to as biochips.

Data generated by quantitation of the amount of a sample component of interest (target) bound to each peptoid on the array (e.g., polypeptides, signal transduction components, immunological components, plasma membrane enzyme mediators, cell cycle components, developmental cycle components, or pathogen components) can be analyzed using any suitable means. In one embodiment, data is analyzed with the use of a programmable digital computer. The computer program generally contains a readable medium that stores codes. Certain code can be devoted to memory that includes the location of each feature on a support, the identity of the binding elements at that feature and the elution conditions used to wash the support surface. The computer also may contain code that receives as input, data on the strength of the signal at various addressable locations on the support. This data can indicate the number of targets detected, including the strength of the signal generated by each target.

Data analysis can include the steps of determining signal strength (e.g., height of peaks) of a target(s) detected and removing “outliers” (data deviating from a predetermined statistical distribution). The observed peaks can be normalized, a process whereby the height of each peak relative to some reference is calculated. For example, a reference can be background noise generated by instrument and chemicals (e.g., energy absorbing molecule) which is set as zero in the scale. Then the signal strength detected for each target can be displayed in the form of relative intensities in the scale desired. Alternatively, a standard may be admitted with the sample so that a peak from the standard can be used as a reference to calculate relative intensities of the signals observed for each target detected.

Data generated by the detector, e.g., the mass spectrometer, can then be analyzed by computer software. The software can comprise code that converts signal from the detector into computer readable form. The software also can include code that applies an algorithm to the analysis of the signal to determine whether the signal represents a “peak” in the signal corresponding to a target. The software also can include code that executes an algorithm that compares signal from a test sample to a typical signal characteristic of “normal” or standard sample and determines the closeness of fit between the two signals. The software also can include code indicating whether the test sample has a normal profile of the target(s) or if it has an abnormal profile.

A binding profile of one or more sample components (biomarkers) that bind a peptoid selected using the methods described herein can be used to predict, diagnose, or assess a condition or disease state in a subject from which the sample was obtained. A disease state or condition includes, but is not limited to cancer, autoimmune disease, inflammatory disease, infectious disease, neurodegenerative disease, cardiovascular disease, bacterial infection, viral infection, fungus infection, prion infection, physiologic state, contamination state, or health in general. The methods of the invention can use binding profiles and selected peptoid ligands to differentiate between different forms of a disease state, including pre-disease states or the severity of a disease state. For example, the methods may be used to determine the metastatic state of a cancer or the susceptibility to an agent or disease state. Embodiments of the invention include methods and compositions for assessing targets present in breast cancer, lung cancer, prostate cancer, cervical cancer, head and neck cancer, testicular cancer, ovarian cancer, skin cancer, brain cancer, pancreatic cancer, liver cancer, stomach cancer, colon cancer, rectal cancer, esophageal cancer, lymphoma, and leukemia.

Further embodiments can be used to assess targets present in autoimmune diseases such as acute disseminated encephalomyelitis (ADEM), acute necrotizing hemorrhagic leukoencephalitis, Addison's disease, agammaglobulinemia, allergic asthma, allergic rhinitis, alopecia areata, amyloidosis, ankylosing spondylitis, anti-GBM/anti-TBM nephritis, antiphospholipid syndrome (APS), autoimmune aplastic anemia, autoimmune dysautonomia, autoimmune hepatitius, autoimmune hyperlipidemia, autoimmune immunodeficiency, autoimmune inner ear disease (AIED), autoimmune myocarditis, autoimmune pancreatitis, autoimmune retinopathy, autoimmune thrombocytopenic purpura (ATP), autoimmune thyroid disease, axonal & neuronal neuropathies, Balo disease, Behcet's disease, bullous pemphigoid, cardiomyopathy, Castlemen disease, celiac sprue (non-tropical) Chagas disease, chronic fatigue syndrome, chronic inflammatory demyelinating polyneuropathy (CIDP), chronic recurrent multifocal ostomyelitis (CRMO), Churg-Strauss syndrome, cicatricial pemphigoid/benign mucosal pemphigoid, Crohn's disease, Cogan's syndrome, cold agglutinin disease, congenital heart block, coxsackie myocarditis, CREST disease, essential mixed cryoglobulinemia, demyelinating neuropathies, dermatomyositis, Devic's disease (neuromyelitis optica), discoid lupus, Dressler's syndrome, endometriosis, eosinophillic fasciitis, erythema nodosum, experimental allergic encephalomyelitis, Evan's syndrome, fibromyalgia, fibrosing alveolitis, giant cell arteritis (temporal arteritis), glomerulonephritis, Goodpasture's syndrome, Grave's disease, Guillain-Barre syndrome, Hashimoto's encephalitis, Hashimoto's thyroiditis, hemolytic anemia, Henock-Schoniein purpura, herpes gestationis, hypogammaglobulinemia, idiopathic thrombocytopenic purpura (ITP), IgA nephropathy, immunoregulatory lipoproteins, inclusion body myositis, insulin-dependent diabetes (type 1), interstitial cystitis, juvenile arthritis, juvenile diabetes, Kawasaki syndrome, Lambert-Eaton syndrome, leukocytoclastic vasculitis, lichen planus, lichen sclerosus, ligneous conjunctivitis, linear IgA disease (LAD), Lupus (SLE), Lyme disease, Meniere's disease, microscopic polyangitis, mixed connective tissue disease (MCTD), Mooren's ulcer, Mucha-Habermann disease, multiple sclerosis, myasthenia gravis, myositis, narcolepsy, neuromyelitis optica (Devic's), neutropenia, ocular cicatricial pemphigoid, optic neuritis, palindromic rheumatism, PANDAS (Pediatric Autoimmune Neuropsychiatric Disorders Associated with Streptococcus), paraneoplastic cerebellar degeneration, paroxysmal nocturnal hemoglobinuria (PNH), Parry Romberg syndrome, Parsonnage-Turner syndrome, pars plantis (peripheral uveitis), pemphigus, peripheral neuropathy, perivenous encephalomyelitis, pernicious anemia, POEMS syndrome, polyarteritis nodosa, type I, II & III autoimmune polyglandular syndromes, polymyalgia rheumatic, polymyositis, postmyocardial infarction syndrome, postpericardiotomy syndrome, progesterone dermatitis, primary biliary cirrhosis, primary sclerosing cholangitis, psoriasis, psoriatic arthritis, idiopathic pulmonary fibrosis, pyoderma gangrenosum, pure red cell aplasis, Raynaud's phenomena, reflex sympathetic dystrophy, Reiter's syndrome, relapsing polychondritis, restless legs syndrome, retroperitoneal fibrosis, rheumatic fever, rheumatoid arthritis, sarcoidosis, Schmidt syndrome, scleritis, scleroderma, Slogren's syndrome, sperm and testicular autoimmunity, stiff person syndrome, subacute bacterial endocarditis (SBE), sympathetic ophthalmia, Takayasu's arteritis, temporal arteritis/giant cell arteries, thrombocytopenic purpura (TPP), Tolosa-Hunt syndrome, transverse myelitis, ulcerative colitis, undifferentiated connective tissue disease (UCTD), uveitis, vasculitis, vesiculobullous dermatosis, vitiligo or Wegener's granulomatosis or, chronic active hepatitis, primary biliary cirrhosis, cadilated cardiomyopathy, myocarditis, autoimmune polyendocrine syndrome type I (APS-I), cystic fibrosis vasculitides, acquired hypoparathyroidism, coronary artery disease, pemphigus foliaceus, pemphigus vulgaris, Rasmussen encephalitis, autoimmune gastritis, insulin hypoglycemic syndrome (Hirata disease), Type B insulin resistance, acanthosis, systemic lupus erythematosus (SLE), pernicious anemia, treatment-resistant Lyme arthritis, polyneuropathy, demyelinating diseases, atopic dermatitis, autoimmune hypothyroidism, vitiligo, thyroid associated ophthalmopathy, autoimmune coeliac disease, ACTH deficiency, dermatomyositis, Sjögren syndrome, systemic sclerosis, progressive systemic sclerosis, morphea, primary antiphospholipid syndrome, chronic idiopathic urticaria, connective tissue syndromes, necrotizing and crescentic glomerulonephritis (NCGN), systemic vasculitis, Raynaud syndrome, chronic liver disease, visceral leishmaniasis, autoimmune C1 deficiency, membrane proliferative glomerulonephritis (MPGN), prolonged coagulation time, immunodeficiency, atherosclerosis, neuronopathy, paraneoplastic pemphigus, paraneoplastic stiff man syndrome, paraneoplastic encephalomyelitis, subacute autonomic neuropathy, cancer-associated retinopathy, paraneoplastic opsoclonus myoclonus ataxia, lower motor neuron syndrome and Lambert-Eaton myasthenic syndrome.

Yet further embodiments of the invention include methods and compositions for assessing ligand binding moieties present in infectious diseases such as Acquired immunodeficiency syndrome (AIDS), Anthrax, Botulism, Brucellosis, Chancroid, Chlamydial infection, Cholera, Coccidioidomycosis, Cryptosporidiosis, Cyclosporiasis, Diphtheria, Ehrlichiosis, Arboviral Encephalitis, Enterohemorrhagic Escherichia coli (E. coli), Giardiasis, Gonorrhea, Haemophilus influenzae, Hansen's disease (leprosy), Hantavirus pulmonary syndrome, Hemolytic uremic syndrome, Hepatitis A, Hepatitis B, Hepatitis C, Human immunodeficiency virus (HIV), Legionellosis, Listeriosis, Lyme disease, Malaria, Measles, Meningococcal disease, Mumps, Pertussis (whooping cough), Plague, Paralytic Poliomyelitis (polio), Psittacosis (parrot fever), Q Fever, Rabies, Rocky Mountain spotted fever, Rubella, Congenital Rubella Syndrome, Salmonellosis, Severe acute respiratory syndrome (SARS), Shigellosis, Smallpox, Streptococcal disease (invasive Group A), Streptococcal toxic shock syndrome (STSS), Streptococcus pneumoniae, Syphilis, Tetanus, Toxic shock syndrome, Trichinosis, Tuberculosis, Tularemia, Typhoid fever, Vancomycin-Intermediate/Resistant Staphylococcus aureus, Varicella, Yellow fever, variant Creutzfeldt-Jakob disease (vCJD), Dengue fever, Ebola hemorrhagic fever, Echinococcosis (Alveolar Hydatid disease), Hendra virus infection, Human monkeypox, Influenza A H5N1 (avian influenza), Lassa fever, Marburg hemorrhagic fever, Nipah virus, O'nyong-nyong fever, Rift Valley fever, Venezuelan equine encephalitis, and West Nile virus (see U.S. Government Accounting Office publication GAO-04-877 “Disease Surveillance”).

In still yet further embodiments, the invention include methods and compositions for assessing a target present in neurodegenerative diseases such as stroke, hypovolemic shock, traumatic shock, reperfusion injury, multiple sclerosis, AIDS, associated dementia; neuron toxicity, Alzheimer's disease, head trauma, adult respiratory disease (ARDS), acute spinal cord injury, Huntington's disease, and Parkinson's Disease.

### III. Screening Assays

Once one or more peptoid is identified as binding a target further characterization of the selected peptoid can be performed in various screening assays as described below. Various cells that express a target can be utilized for screening of candidate substances. A number of cells and cell lines are available for use in cell based assays. Cells include, but are not limited to human vascular endothelial cells (HUVECs) and various cancer cell lines, as well as primary cells from individuals. Depending on the assay, culture may be required. Labeled candidate peptoids may be contacted with the cell and binding assessed therein. Various readouts for binding of candidate substances to cells may be utilized, including ELISA, fluorescent microscopy and FACS.

The present invention particularly contemplates the use of various animal models. For example, various animal models of cancer may be used to determine if the candidate peptoids inhibit cancer cell growth, metastasis or recurrence, affect its ability to evade the effects of other drugs or provide other therapeutic effects. Treatment of these animals with test compounds will involve the administration of the compound, in an appropriate form, to the animal. Administration will be by any route the could be utilized for clinical or non-clinical purposes, including but not limited to oral, nasal, buccal, or even topical. Alternatively, administration may be by oral, sublingual, intratracheal instillation, bronchial instillation, intradermal, subcutaneous, intramuscular, intraperitoneal or intravenous injection. The present invention also contemplates pharmaceutical compositions comprising affinity ligands selected from peptoids identified through the screening methods described herein and a pharmaceutically acceptable excipient.

Cell based screening assays can be used to identify target-specific ligands, such as peptoids. Cells having differential characteristics, such as the presence or absence of a cell surface receptor, but otherwise identical, are differentially labeled (e.g., two different colored quantum dots). The cells are then mixed in an approximately 1:1 ratio and then exposed to a library of molecules displayed on a substrate. After appropriate incubation and washing, the beads that bind only one color cell are picked. The beads are treated to remove the cells and other debris, and the bound molecule is identified by an appropriate analytical technique. This two-color assay demands extremely high specificity. If the bead-displayed molecule binds any other molecule on the cell surface other than the target, then both colored cells will be retained and the molecule will not be identified as a hit (Udugamasooriya et al., 2008).

The assay can be modified to accommodate a variety of different formats. For example, a three cell types assay can be used to distinguish ligands that bind to highly related molecules. For example, where two receptors are almost identical, cells are provided that are null or have one or the other related receptor. Each cell type (null, receptor 1-containing and receptor 2-containing) is labeled with a different agent (e.g., colored quantum dot). The cells are mixed together in an approximately 1:1:1 ratio and exposed to a bead library. Beads that bind only one color cell are picked and the chemical that they display is characterized.

Examples of structures that can be differentiated include antibody or T-cell receptors of various immune cells, growth factor receptors, cell matrix proteins, lectins, carbohydrates, lipids, cell surface antigens from various pathogens. Additionally, the cells could differ not in the composition of the cell surface molecules, but in their arrangement. For example on one cell type, two given cell surface molecules might associate with one another and provide a unique binding site for a ligand that might be absent from a different cell type where these receptors do not associate. Labeling can utilize calorimetric, fluorometric, bioluminescent or chemiluminescent labels.

The assay can also be modified to identify ligands that bind to cells present in only one of two or more distinct cell populations. For example, all CD4+ T cells from a healthy individual or group of individuals could be labeled with one colored dye and the CD4+ T cells from an individual or group of individuals with an autoimmune disease could be labeled with a different colored dye. The two populations of T cells could then be mixed with the bead library and beads retaining only cells from the autoimmune patients could be selected. These T cells would be candidates for the autoimmune T cells that display the T cell Receptor (TCR) that binds the autoantigen and contributes to disease, since these cells should only be abundant in the autoimmune samples and not in cells obtained from healthy individuals.

In another application, the two or more cell populations could differ solely in the presence or absence of a genetic mutation that might result in a change in the composition and/or organization of molecules on the cell surface.

### IV. Kits

Any of the compositions described herein may be comprised in a kit. In a non-limiting example, peptoids, peptoid arrays and related support(s), buffers, linkers, and reagents are provided in a kit. The kit may further comprise reagents for processing a sample and/or sample components. The kit may also comprise reagents that may be used to label various components of an array or sample, with for example, radio isotopes or fluorophors.

Kits for implementing methods of the invention described herein are specifically contemplated. In some embodiments, there are kits for synthesis, processing, and detection of peptoids that bind a target.

Regents for the detection of target binding can comprise one or more of the following: array substrate; peptoids; and/or detection reagents.

The components of the kits may be packaged either in aqueous media or in lyophilized form. The container means of the kits will generally include at least one vial, test tube, plate, flask, bottle, array substrate, syringe or other container means, into which a component may be placed, and preferably, suitably attached. Where there is more than one component in the kit (labeling reagent and label may be packaged together), the kit also will generally contain a second, third or other additional container into which the additional components may be separately placed. However, various combinations of components may be comprised in a vial. The kits of the present invention also will typically include a means for containing binding elements or reagents for synthesizing such, and any other reagent containers in close confinement for commercial sale. Such containers may include injection or blow molded plastic containers into which the desired vials are retained.

When components of the kit are provided in one and/or more liquid solutions, the liquid solution is typically an aqueous solution that is sterile and proteinase free. In some cases proteinaceous compositions may be lyophilized to prevent degradation and/or the kit or components thereof may be stored at a low temperature (i.e., less than about 4° C.). When reagents and/or components are provided as a dry powder and/or tablets, the powder can be reconstituted by the addition of a suitable solvent. It is envisioned that the solvent may also be provided in another container means.

### V. Examples

The following examples are given for the purpose of illustrating various embodiments of the invention and are not meant to limit the present invention in any fashion. One skilled in the art will appreciate readily that the present invention is well adapted to carry out the objects and obtain the ends and advantages mentioned, as well as those objects, ends and advantages inherent herein. The present examples, along with the methods described herein are presently representative of preferred embodiments, are exemplary, and are not intended as limitations on the scope of the invention. Changes therein and other uses which are encompassed within the spirit of the invention as defined by the scope of the claims will occur to those skilled in the art.

### EXAMPLE 1

### Bead To Microarray Screening

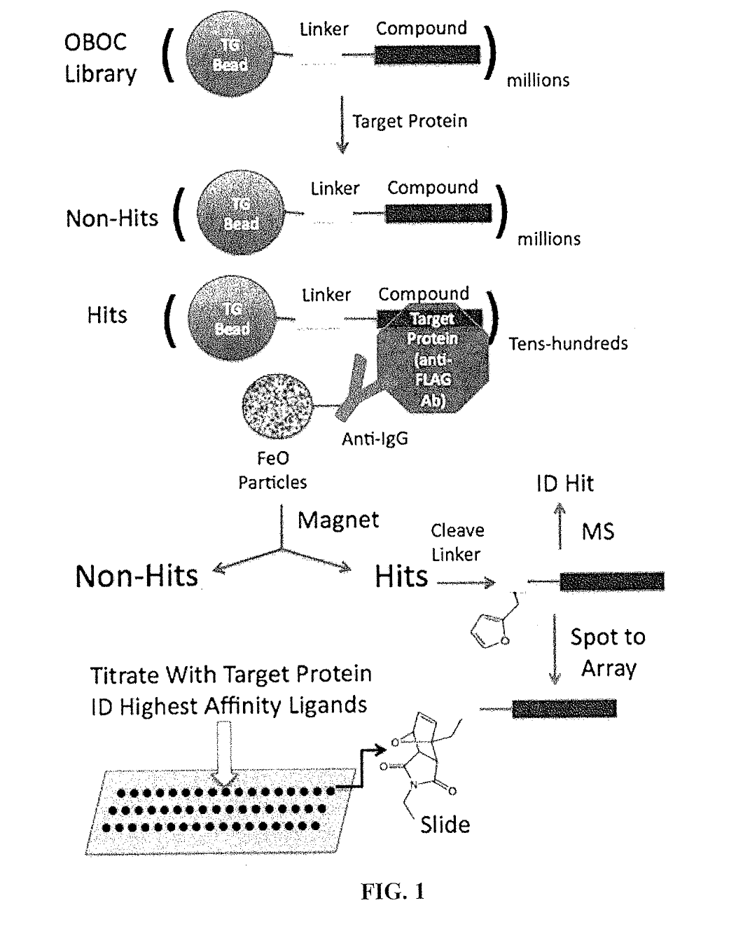

The central goal of this study was to establish a screening strategy that would allow millions of bead-displayed compounds to be screened on resin rapidly and cheaply, followed by transfer of the hits to a microarray where their binding to the target of interest could be quantified (FIG. 1). Previous work has shown that TentaGel, comprised of a polystyrene core coated with very long amine-terminated polyethylene glycol (PEG) chains is a superior bead surface for protein-binding screens due to its low nonspecific protein-binding capacity (Alluri et al., 2003). However, there is no simple way to release molecules built off of the terminal amine group from the resin. Therefore, the inventors developed a suitable linker arm that would support both efficient cleavage of hits from the beads and subsequent spotting onto maleimide-modified glass slides (Reddy and Kodadek, 2005).

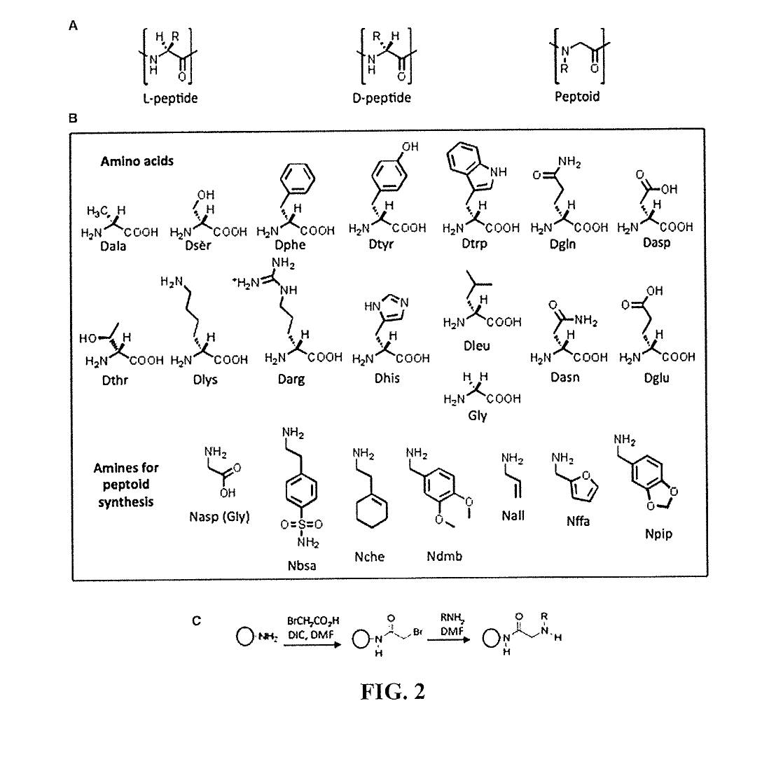

In certain examples, two linker types were explored, both based on protocols for the specific cleavage of proteins: the cyanogen bromide-mediated cleavage C-terminal of methionine (Thakkar et al., 2009), and hydrolysis of the Asp-Pro peptide bond with dilute trifluoroacetic acid (TFA) (Crimmins et al., 2005). In the case of the Asp-Pro linker, a Cys residue was included to facilitate Michael addition of the cleaved molecule to the maleimide-terminated slides. In the Met-containing linkers, it was found that a Cys residue led to side-reactions that decreased the purity of cleaved compounds, and rendered identification of the hit compounds more difficult (data not shown). Therefore, a furan-containing peptoid residue (Nffa; see FIGS. 2A-C) was incorporated into the peptoids of the library for supporting linkage to the array via Diels-Alder reaction (Houseman et al., 2002). FLAG peptide or Myc peptide was synthesized on 75 μm TentaGel beads with either the Cys-Asp-Pro or Nffa-Met linker (written in the N-to-C direction). It was demonstrated that enough compound is produced from cleavage of a single bead with CNBr or dilute TFA to sequence the peptide using tandem MALDI mass spectrometry (MS). Moreover, when the compound was spotted onto an array and probed with either anti-Myc or anti-FLAG antibody, enough antibody was captured to easily detect a signal upon subsequent incubation with fluorescently labeled secondary antibody. More extensive work with small libraries showed that the Nffa-Met linker produced somewhat cleaner results when the molecules were sequenced by MS, but that about two-fold less compound was spotted onto the slides when compared with the Cys-Asp-Pro-linked compounds. While both linkers are suitable for use, the inventors employed the Nffa-Met for this study.

A combinatorial library was made by split and pool synthesis with the composition NH₂-X₆-Nffa-Met-TentaGel, where X=Nall, Nbsa, Nche, Ndmb, Npip, Gly, Dala, Darg, Dasn, Dasp, Dgln, Dglu, Dhis, Dleu, Dlys, Dphe, Dser, Dthr, Dtrp, or Dtyr (FIGS. 2A-C). Peptide couplings were done in the usual way, whereas the peptoid residues were inserted using the submonomer method of Zuckermann and et al. (Figliozzi et al., 1996) (FIG. 2C). The theoretical diversity of the library was 20⁶ (64 million) compounds. Approximately 1 g of 75 μm TentaGel resin, consisting of about four million beads, was employed for the synthesis, so most of the beads should display a unique D-peptide or D-peptide-peptoid hybrid. To carry out the screen, approximately two million beads were incubated with anti-FLAG antibody (67 nM in 5% milk blocking buffer) as a model target protein. This antibody recognizes the octapeptide N-Asp-Tyr-Lys-Asp-Asp-Asp-Asp-Lys-C with high affinity. In previous studies, the inventors had employed biotinylated proteins as targets, and identified beads displaying protein-binding molecules by examination of the entire population under a fluorescent microscope after incubation with streptavidin (SA)-coated quantum dots. However, this is impractical with millions of beads, so the inventors developed a more facile procedure to enrich hits from the library. After incubation of the antibody with the beads, secondary antibody-coated iron oxide particles (Invitrogen/Dynal) were added to the tube, and the suspension was mixed. A strong magnet was then placed on the side of the tube, which was then made vertical. It was contemplated that TentaGel beads that had bound the anti-FLAG antibody would be retained by the magnet through a peptide/peptoid-anti-FLAG antibody-secondary antibody-Dynabead bridging interaction (FIG. 1), while beads that did not bind to the anti-FLAG antibody would settle to the bottom of the tube. To ensure that no potential hits were left behind, after pipetting off the beads that did not bind to the magnet, new Dynabeads were introduced to this population and repeated the magnetic isolation procedure. Two rounds picked up several beads that were not retained by the magnet in the first round, but additional rounds did not yield more hits.

TABLE 1
Complete Sequences Of Hits From The X-X-X-X-X-X-Nffa-Met On-Bead Library Screen

| | K_{D} | | | | | | | | |
|---|---|---|---|---|---|---|---|---|---|
| Spot | (̅n̅M̅)̅ | Sequence | | | | | | | |
| A6 | NA | Dphe | Dtyr | Gly | Dleu | Dlys/gln | Nche | Nffa | (Met) |
| A7 | 5 | Dasn | Dlys/gln | Dtyr | Dala | Dasp | Dasp | Nffa | (Met) |
| A8 | NA | Dasn | Nall | Dphe | Dtyr | Nall | Dleu | Nffa | (Met) |
| B1 | 3 | Nall | Dthr | Dlys/gln | Dtyr | Dasp | Dasp | Nffa | (Met) |
| B3 | 11 | | Dlys/gln | Dtyr | Dasp | Nche | Dglu | Nffa | (Met) |
| B4 | 7 | Dglu | Dlys/gln | Dtyr | Darg | Dtyr | Dtrp | Nffa | (Met) |
| B7 | 6 | Dleu | Dasp | Dlys/gln | Dtyr | Dglu | Dtrp | Nffa | (Met) |
| B8 | 9 | Dasp | Dlys/gln | Dtyr | Dphe | Dser | Nbsa | Nffa | (Met) |
| B9 | 2 | Dglu | Dser | Dlys/gln | Dtyr | Dasp | Dtyr | Nffa | (Met) |
| B10 | NA | Dlys/gln | Dtyr | Dglu | Dphe | Dasp | Dlys/gln | Nffa | (Met) |
| C1 | 5 | Ndmb | Dasp | Dlys/gln | Dtyr | Dleu | Dasn | Nffa | (Met) |
| C4 | 6 | Dphe | Dasp | Dlys/gln | Dtyr | Dtrp | Dlys/gln | Nffa | (Met) |
| C5 | NA | Dala | Nall | Nall | Nche | Dlys/gln | Darg | Nffa | (Met) |
| C7 | NA | Dasp | Dlys/gln | Dtyr | Dglu | Nbsa | Dser | Nffa | (Met) |
| C8 | NA | Dhis | Dthr | Dasn | Npip | Nbsa | Dlys/gln | Nffa | (Met) |
| D1 | 28 | | Nall | Npip | Dasp | Dlys/gln | Dtyr | Nffa | (Met) |
| D2 | NA | Dthr | Dhis | Dglu | Nbsa | Dleu | Dala | Nffa | (Met) |
| D3 | NA | Nche | Dlys/gln | Dthr | Dhis | Gly | Dleu | Nffa | (Met) |
| D4 | 3 | | Dlys/gln | Dtyr | Dtrp | Nbsa | Dphe | Nffa | (Met) |
| D5 | 7 | Dlys/gln | Dtyr | Dtyr | Dasn | Dasp | Npip | Nffa | (Met) |
| D7 | 3 | Dasp | Dser | Dlys/gln | Dtyr | Dser | Nbsa | Nffa | (Met) |
| D8 | 6 | Dlys/gln | Dtyr | Dala | Dasn | Dphe | Dglu | Nffa | (Met) |
| D9 | 4 | Dlys/gln | Dtyr | Dser | Dleu | Dasp | Nbsa | Nffa | (Met) |
| E1 | 5 | | Npip | Dlys/gln | Dtyr | Dglu | Dser | Nffa | (Met) |
| E3 | 17 | Dlys/gln | Dtyr | Dglu | Dasn | Dglu | Nall | Nffa | (Met) |
| E4 | 8 | Dlys/gln | Dtyr | Npip | Gly | Dasp | Nall | Nffa | (Met) |
| E5 | NA | | Darg | Dtyr | Nbsa | Nall | Darg | Nffa | (Met) |
| E7 | 4 | Dlys/gln | Dtyr | Dasp | Dlys/gln | Dasn | Dthr | Nffa | (Met) |
| E8 | 9 | Dasp | Dphe | Dlys/gln | Dtyr | Dala | Dglu | Nffa | (Met) |
| H1 | 6 | Dlys/gln | Dtyr | Dglu | Dtyr | Dglu | Dtyr | Nffa | (Met) |
| H2 | 5 | Dlys/gln | Dtyr | Dasp | Nbsa | Nbsa | Dasp | Nffa | (Met) |
| H4 | 5 | Dlys/gln | Dtyr | Dglu | Dglu | Darg | Dlys/gln | Nffa | (Met) |
| H6 | 11 | Dlys/gln | Dtyr | Dasp | Dtrp | Dglu | Gly | Nffa | (Met) |
| H7 | 9 | Dlys/gln | Dtyr | Dtyr | Dglu | Dasn | Npip | Nffa | (Met) |
| H8 | 2 | Dtrp | Dasp | Dlys/gln | Dtyr | Dhis | Nbsa | Nffa | (Met) |
| H9 | 4 | Dlys/gln | Dtyr | Dasp | Nall | Dglu | Dleu | Nffa | (Met) |
| I1 | NA | Dleu | Dlys/gln | Nbsa | Dser | Dlys/gln | Dasn | Nffa | (Met) |

Spots bound by anti-FLAG antibody on microarrays are in plain text. Spots not bound by anti-FLAG antibody on microarrays are in bold. Dlys/gln = Dlys or Dgln, which were indistinguishable by MS; 27 of 27 hits bound by anti-FLAG antibody on the microarrays contained the sequence Dlys/gln-Dtyr.

A total of 63 beads were retained by the magnet and separated manually into individual wells of a microtiter plate. The inventors also included, in other wells as negative controls, several beads that were not retained by the magnet. Beads displaying FLAG peptide-Nffa-Met and Myc peptide-Nffa-Met were also included as further controls. The compounds were released into solution by treatment with 30 mg/ml CNBr in 5:4:1 acetonitrile:acetic acid:water overnight. After transferring the resultant solution to a new plate, the solvent was evaporated and the compounds were processed as described, such that some of the sample was used to spot onto maleimide-activated, PEGylated glass slides, and some was employed for MALDI MS-based sequencing. About 60% of the hits could be sequenced unambiguously (see Table 1).

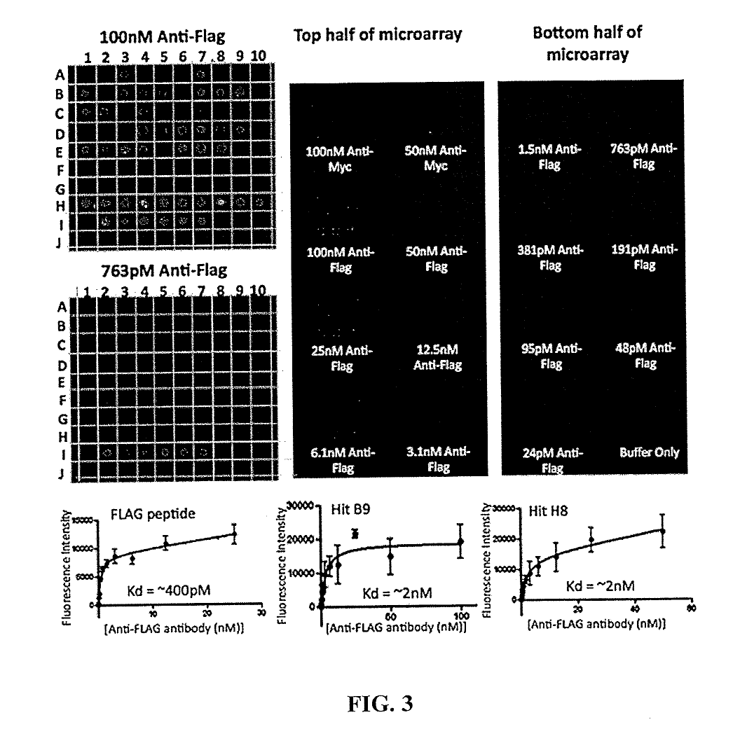

A total of 16 copies of each array of 100 compounds (the hits and various controls) were spotted onto each microscope slide. Each array, isolated by applying a Whatman Fast Frame to the slide, was then incubated for 2 hr with either anti-Myc antibody or various concentrations of anti-FLAG antibody. After washing, the amount of antibody captured at each spot was quantified by subsequent hybridization with fluorescently labeled secondary antibody, another wash, drying, and scanning. Some of the results are shown in FIG. 3. From these data, quantitative binding curves for each compound spotted on the array could be derived (see FIG. 3 and Table 1). No binding of the anti-FLAG antibody to the Myc peptide was observed, nor was binding of the anti-Myc antibody to any of the hits or the FLAG peptide.

The data show that the compounds separate into two distinct classes: high-affinity anti-FLAG ligands, and those that do not bind the antibody detectably (false positives from the bead screen). The best of the hits had apparent Kds only about fivefold higher than the native FLAG peptide antigen (see FIG. 3 and Table 1), while many displayed 10- to 100-fold lower affinity.

To address if the higher affinity hits bind to anti-FLAG antibody in the antigen-binding site, the inventors carried out a competition experiment in which the anti-FLAG antibody was first incubated with an excess of FLAG peptide or, as a control, the Myc peptide, before hybridization to the array. The soluble FLAG peptide abrogated binding of the antibody to all of the molecules on the microarray, whereas the Myc peptide had little or no effect. While the inventors cannot absolutely rule out allosteric competition, these data argue that all of the ligands derived from this screen bind to the peptide-binding site of the antibody.

Library Hybridization and Magnetic Screening. TBST-swelled beads were washed with TBST, then blocked with 50 mg/ml dried skim milk (Carnation) in 1:1 TBST:StartingBlock (Sigma) for 1 hr at room temperature (RT) in a 5 ml or 10 ml disposable reaction column. M2 monoclonal anti-flag antibody (Sigma) was diluted in 50 mg/ml milk in 1:1 TBST:StartingBlock at a concentration of 10 μg/ml and hybridized to beads for 1 hr at RT. Beads were washed with TBST eight times, resuspended in StartingBlock, and transferred to a 15 ml conical tube; 10 ml of 10 μg/ml sheep anti-mouse IgG antibody-conjugated M280 Dynabeads was added per milliliter of StartingBlock. Typically, 3 ml of solution was used per ˜500,000 beads screened at each of the hybridization steps. For the library screen in which biotinylated beads were added to the library, the beads were suspended in 6 ml of buffer. The Dynabeads were hybridized with the library beads anywhere from 20 min to 2 hr. TBST was added to the tubes up to 14 ml, then the 15 ml conicals were placed in a DynaMag-15. Tubes were inverted slowly for 2 min and then left upright until the beads settled to the bottom. Solution and the beads at the bottom of the tube were transferred with a 5 ml pipette to a new 15 ml conical. Two more washes were performed, where 14 ml TBST was added, the tubes were inverted and placed back into the DynaMag-15, and the solution drained as before (hit beads should be stuck on the sides of the tubes while in the DynaMag-15). After the last wash, 1 ml TBST was added to the tube, and all beads and Dynabeads were collected to the TBST by inversion and rotation of the tube. The beads and TBST were transferred to a 1.5 ml Eppendorf tube and placed under a dissecting microscope. A hand-held rectangular rare-earth metal magnet was very carefully placed next to the tube, and the tube rotated while visualizing the beads under the microscope. Hit beads should follow the magnet, while any negatives should stay at the bottom of the tube. Any negative beads were removed from the bottom with a 200 ml pipetteman, while the hits were kept on the side of the tube next to the magnet. The tube was inverted until all Dynabeads were in suspension, and the tube centrifuged briefly to let the hits settle to the bottom while the Dynabeads stayed in suspension. This was accomplished by pressing “short spin” until the speed reached 2500 rpm, or by pressing “start” and then “stop” as soon as the speed reached 2500 rpm.

While visualizing the clump of hit beads on the bottom of the tube, most of the dynabeads and TBST was drained from the top using a 1000 ml pipetteman. HPLC water (1 ml) was added to the tube, and the tube inverted and spun down as before. Again, most of the solution was drained while taking great care not to suck up the beads from the bottom of the tube. This washing step was repeated six times. For hit beads from libraries containing the methionine linker, most of the water was drained, and 1 ml acetonitrile was added. Beads were then transferred to a 96-well plate and sorted one bead per well under a dissecting microscope. This can be quite tedious or simple, depending on technique. At this point, 20 ml of 30 mg/ml CNBr in 5:4:1 acetonitrile:AcOH:water was added per well, and the plate covered with sticky foil and placed on a shaker at RT overnight. The next day, the foil was removed and the 96 well plate left to air dry in a chemical hood for several hours. HPLC-grade water (20 ml) was added, and the plate covered and left on a shaker for 1 hr at RT; 10 ml from each well was transferred to a 384 well plate containing 10 ml/well DMSO, and the plate sealed and set aside for microarray spotting. Acetonitrile (10 ml) was added to each of the wells in the 96-well plate containing hit beads. This plate was sealed and set aside for MS sequencing. For hit beads containing the Asp-Pro linker, after the water washing of hit beads to remove most of the Dynabeads and TBST, beads were resuspended in HPLC-grade water and transferred to a small Petri dish under a dissecting microscope. A 10 ml pipetteman was set at 1 ml, and beads were transferred one bead at a time to thin-walled PCR tubes; 20 ml per tube of 0.1% TFA in water was added, and the tubes heated to 95° C. in a PCR machine with heated lid for 40 min. Aliquots (10 μl well) were transferred to a 384 well plate containing 10 μl DMSO for microarray spotting. Acetonitrile (10 μl/well) was added to the 96 well plate containing hit beads for subsequent MS sequencing.

Microarray Spotting, Hybridization, and Data Analysis. Contents of the 384-well plates were printed onto maleimide-coated glass slides with a NanoPrint LM 360 (TeleChem International Inc., Sunnyvale, Calif.) with MP946 Micro Spotting Pins. A 10% ethanol (EM-AX007309; Midwest Grain Products) and water mixture was used to wash the pins before printing and after spotting of each compound. Multiple wash/sonicate/dry cycles were used between each sample pick-up and print cycle. Spots were printed on the slide to fit within the wells of a 16-well Whatman Fast Frame (Whatman no. 10486003), which allows 16 isolated hybridization events on a single slide. Slides were left in 50% humidity for 12 hr before printing. After printing, the humidifier was turned off and the slides were left for at least 12 hr before free maleimide groups were blocked with 2% β-mercaptoethanol in DMF for 1 hr by placing the slides in glass slide holders inside of glass containers on a shaker in the chemical hood. Slides were washed sequentially with DMF for 30 min, tetrahydrofuran for 30 min, DMF for 30 min, acetonitrile thrice for 20 min, isopropanol thrice for 20 min, 13 TBST once for 20 min, then 0.13 TBST once for 20 min. Washed slides were spun dry for 5 min at 2000 rpm.

Dry slides were placed inside the Whatman Fast Frame following the provided instructions, and each of the 16 wells per slide was blocked with 100 μl of StartingBlock (Fisher) for 1 hr at RT with a multichannel pipetteman. Wells were drained and washed once with 120 ml TBST. TBST was drained one well at a time before adding 100 μl of appropriate concentrations of protein(s) diluted in 1:1 TBST:StartingBlock. The FastFrame was placed on wet paper towels inside of a glass cake pan, which was sealed with Glad Press'n Seal and placed on an orbital shaker for 2-4 hr at RT. Each well was washed with TBST six times before adding 4 μg/ml Alexa647 goat anti-mouse IgG secondary antibodies diluted in 1:1 TBST:StartingBlock for 1 hr at RT. Slides were washed five times for 3 min with 13 TBST, then once with 0.13 TBST, spun dry at 2000 rpm, then scanned using a GenePix Autoloader 4200AL Scanner (Molecular Devices, Sunnyvale Calif.). Slides were scanned with a power of 1003 and photomultiplier tube setting of 5003-6003. Gal files were created and used to determine fluorescence intensity of each of the spots with GenePixPro6.0. Gal files were aligned manually, then automatic spotfinding followed by manual correction of spots performed for each of the scanned slides. GPR files were created and median fluorescence-background fluorescence values for each of the spots were cut and pasted in Excel and arranged (using simple macros) to simplify transferring results to GraphPad Prism 5.0 software for binding curve analyses.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

### REFERENCES

The following references, to the extent that they provide exemplary procedural or other details supplementary to those set forth herein, are specifically incorporated herein by reference.
Alluri, P. G., Reddy, M. M., Bacchawat-Sikder, K., Olivos, H. J., and Kodadek, T. (2003). Isolation of protein ligands from large peptoid libraries. J. Am. Chem. Soc. 125, 13995-14004.
Bradner, J. E., McPherson, O. M., Mazischek, R., Barnes-Seeman, D., Shen, J. P., Dhaliwal, J., Stevenson, K. E., Duffner, J. L., Park, S. B., Neuberg, D. S., et al. (2006). A robust small-molecule microarray platform for screening cell lysates. Chem. Biol. 13, 493-504.
Crimmins, D. L., Mische, S. M., and Denslow, N. D. (2005). Chemical cleavage of proteins in solution. Curr. Protoc. Protein Sci. Chapter 11, Unit 11.4. 10.1002/0471140864.ps1104s40.
Erlanson, D. A., Wells, J. A., and Braisted, A. C. (2004). Tethering: fragment based drug discovery. Annu. Rev. Biophys. Biomol. Struct. 33, 199-223.
Figliozzi, G. M., Goldsmith, R., Ng, S. C., Banville, S. C., and Zuckermann, R. N. (1996). Synthesis of N-substituted glycine peptoid libraries. Methods Enzymol. 267, 437-447.
Houseman, B. T., Huh, J. H., Kron, S. J., and Mrksich, M. (2002). Peptide chips for the quantitative evaluation of protein kinase activity. Nat. Biotechnol. 20, 270-274.
Kuruvilla, F. G., Shamji, A. F., Sternson, S. M., Hergenrother, P. J., and Schreiber, S. L. (2002). Dissecting glucose signaling with diversity-oriented synthesis and small-molecule microarrays. Nature 416, 653-657.
Lam, K. S., and Renil, M. (2002). From combinatorial chemistry to chemical microarray. Curr. Opin. Chem. Biol. 6, 353-358.
Lam, K. S., Salmon, S. E., Hersh, E. M., Hruby, V. J., Kazmierski, W. M., and Knapp, R. J. (1991). A new type of synthetic peptide library for identifying ligand-binding activity. Nature 354, 82-84.
Liu, R., Marik, J., and Lam, K. S. (2002). A novel peptide-based encoding system for “one-bead one-compound” peptidomimetic and small molecule combinatorial libraries. J. Am. Chem. Soc. 124,7678-7680.
MacBeath, G., Koehler, A. N., and Schreiber, S. L. (1999). Printing small molecules as microarrays and detecting protein-ligand interactions en masse. J. Am. Chem. Soc. 121, 7967-7968.
Maly, D. J., Choong, I. C., and Ellman, J. A. (2000). Combinatorial target-guided ligand assembly: identification of potent subtype-selective c-Src inhibitors. Proc. Natl. Acad. Sci. USA 97, 2419-2424.
Ohlmeyer, M. H., Swanson, R. N., Dillard, L. W., Reader, J. C., Asouline, G., Kobayashi, R., Wigler, M., and Still, W. C. (1993). Complex synthetic chemical libraries indexed with molecular tags. Proc. Natl. Acad. Sci. USA 90,10922-10926.
Reddy, M. M., and Kodadek, T. (2005). Protein “fingerprinting” in complex mixtures with peptoid microarrays. Proc. Natl. Acad. Sci. USA 102,12672-12677.
Shuker, S. B., Hajduk, P. J., Meadows, R. P., and Fesik, S. W. (1996). Discovering high-affinity ligands for proteins: SAR by NMR. Science 274,1531-1534.
Thakkar, A., Cohen, A. S., Connolly, M. D., Zuckermann, R. N., and Pei, D. (2009). High-throughput sequencing of peptoids and peptide-peptoid hybrids by partial edman degradation and mass spectrometry. J. Comb. Chem. 11,294-302.
Uttamchandani, M., Walsh, D. P., Yao, S. Q., and Chang, Y. -T. (2005). Small molecule microarrays: recent advances and applications. Curr. Opin. Chem. Biol. 9, 4-13.

What is claimed is:

1. A method for selecting a peptoid comprising:
contacting a peptoid library with a target, the peptoid library comprising a plurality of beads with each bead being coupled to a specific peptoid via a cleavable linker;
selecting a target-bound peptoid by coupling the target with a magnetic particle forming a magnetic particle complex; and
isolating the magnetic particle complex containing the target-bound peptoid.

2. The method of claim 1, further comprising separating individual magnetic particle complexes into separate wells or containers.

3. The method of claim 2, further comprising cleaving the link between the bead and the selected peptoid and attaching the selected peptoid to a substrate forming a selected peptoid array.

4. The method of claim 3, wherein cleaving the link between the bead and the selected peptoid is by exposure to cyanogen bromide or trifluoro-acetic acid (TFA).

5. The method of claim 3, wherein the selected peptoid array is formed by microarray spotting.

6. The method of claim 3, wherein the cleaved peptoid comprises a furan group for coupling to the substrate.

7. The method of claim 3, wherein the substrate is glass.

8. The method of claim 7, wherein the glass is maleimide-modified glass.

9. The method of claim 1, wherein the target is a polypeptide.

10. The method of claim 9, wherein the polypeptide is on the surface of a cell or particle.

11. The method of claim 10, wherein the cell is a eukaryotic cell, a prokaryotic cell, or a phage particle.

12. The method of claim 3, further comprising contacting the array with varying concentrations of the target and assessing binding of the target to the selected peptoid array at the various concentrations.
